(19) United States
(12) Patent Application Publication
(10) Pub. No.: US 2006/0112033 A1
(43) Pub. Date: May 25, 2006

(54) Ultrasound user interface learning system

(76) Inventors: Michael Vion, Bothell, WA (US); Jonas Olsson, Woodinville, WA (US)

Correspondence Address: PHILIPS INTELLECTUAL PROPERTY & STANDARDS, P.O. BOX 3001, BRIARCLIFF MANOR, NY, 10510, US

(21) Appl. No.: 11/229,159

(22) Filed: Sep. 16, 2005

Related U.S. Application Data
(60) Provisional application No. 60/618,012, filed on Oct. 12, 2004.

(51) Int. Cl. G06F 15/18

(52) U.S. Cl. 706/16

(57) ABSTRACT

Default values (220) for parameters to be used in a process on an apparatus are automatically learned from the user's interaction with the user interface (126). Learning is based, for each parameter, on a current value inputted to the process and on one or more corresponding past values (S332). More particularly, for numerical-valued parameters, an average and preferably a rolling average may be taken (404, 408). For non-numerically-valued parameters, the highest plurality of occurrence may be computed, this likewise being preferably based on a rolling window (412, 416).

The present invention relates to default input parameters to a process and a user interface to an apparatus performing the process. More particularly, the present invention relates to the automatic learning of user preferences and the automatic determination of default input parameters.

In a number of imaging applications, the user has to modify a large set of parameters in order to optimize a visualized image. The values of these parameters remain fairly constant for a particular user who wants to highlight some characteristics of the image, although these values may differ from those preferred by another user. The other user may be, for example, an end user like a doctor or a patient who is viewing a printed image, e.g., of the face of a fetus, provided by the technician or other operator of the imaging device. Based on feedback from the end user, the user may subsequently adjust parameters and produce a subsequent image for the end user. Afterwards, images taken by the user may only reflect the user's preferences with sporadic instances in which the image is again based on feedback from the end user or another end user.

It can be time consuming to repeat all the parameter adjustments for each image, especially in the medical field, where workflow is important. The present inventors have observed that time is unnecessarily wasted in modifying the defaults to optimize the image that is to be immediately acquired. If, for example, end-user feedback becomes frequent, default values for the parameters should take this into account, rather than reflect merely the user's preferences. On the other hand, simply making the last-used value the default excludes learning except from isolated instances.

The learning tool of the present invention takes both current and recent past experience into account in adjusting a set of parameters automatically or at the touch of a button. Although described by way of example in a specific context, the instant learning tool may be implemented in a wide variety of applications that feature a user interface.

It is an object of the invention to enable an apparatus to learn, for a user interface having input and output devices, default values to be used in executing a process on the apparatus. The apparatus includes a memory and a processor. The processor detects a desired result of executing the process. In response, current parameter values are saved and default values for the parameters are calculated based the current parameter value and at least one past value for that parameter. The default values calculated are supplied to the user interface for possible subsequent modification by the user.

Details of the invention disclosed herein shall be described with the aid of the figures listed below, wherein:

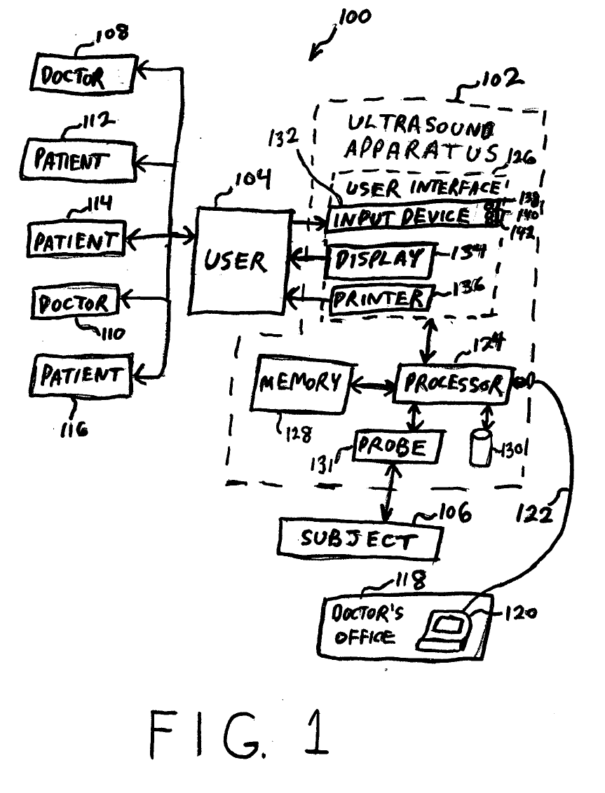

FIG. 1 is a diagram showing information flow between elements of a system in accordance with the present invention;

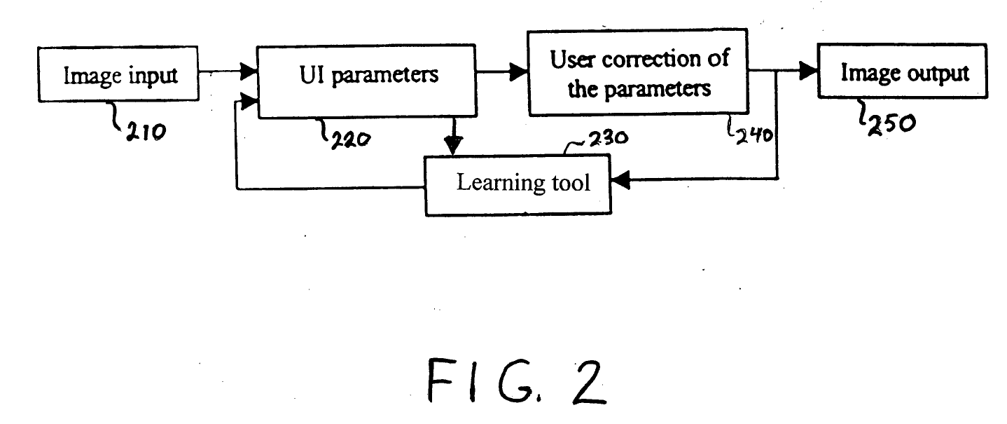

FIG. 2 is conceptual diagram of operation of an apparatus to which the user interface pertains, in accordance with the present invention;

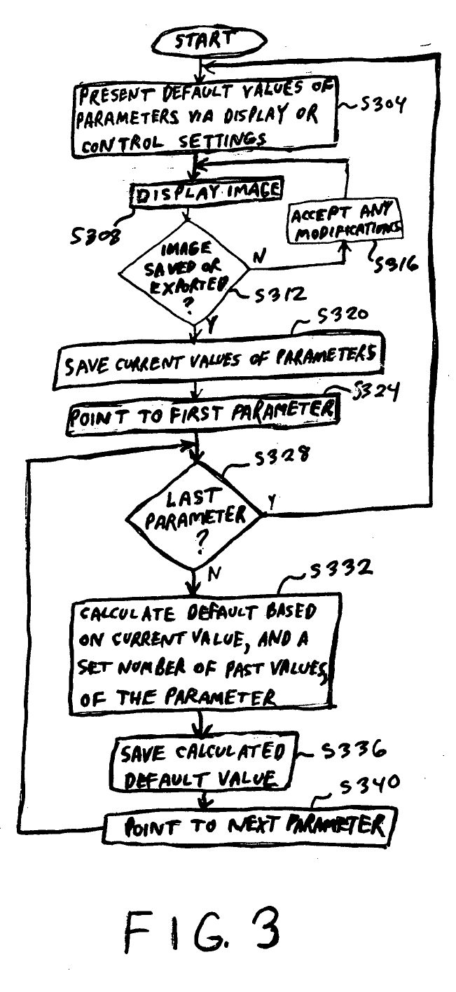

FIG. 3 is a flowchart detailing the operation shown in FIG. 2; and

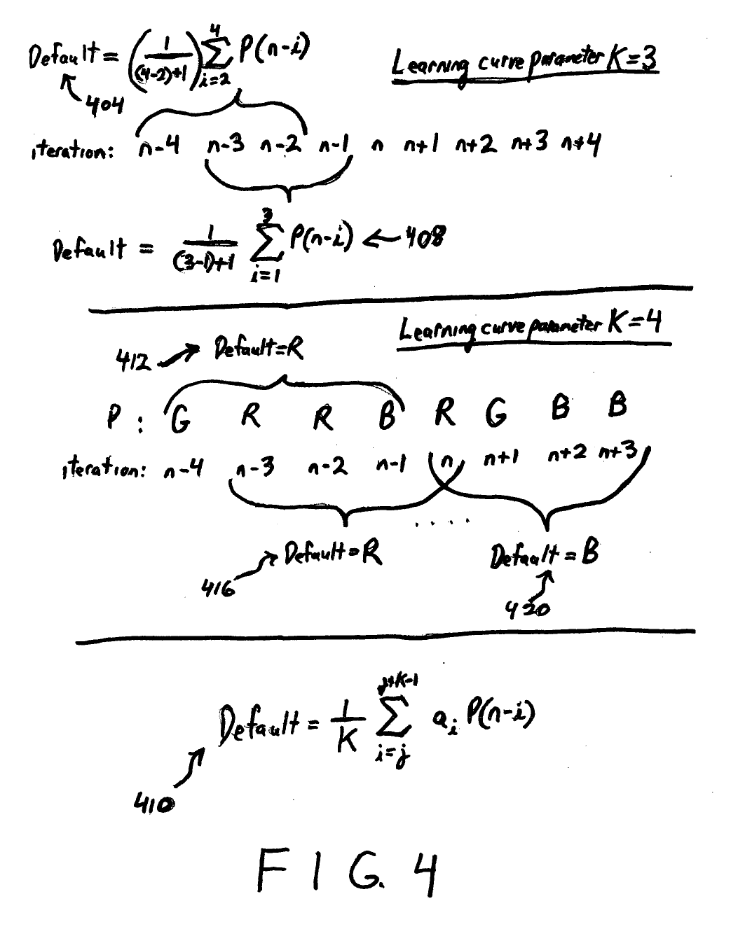

FIG. 4 is a conceptual diagram explaining default-value calculation in accordance with the present invention.

Referring to FIG. 1, an ultrasound system 100 in accordance with the present invention includes, by way of illustrative and non-limitative example, an ultrasound apparatus 102, a user 104 of the ultrasound apparatus, a subject or patient 106, end-users such as doctors 108, 110 who provide feedback to the user after having viewed an image, and patients 112, 114, 116 or relatives/friends of patients who provide feedback. The latter may include the subject 106. A remotely-located doctor's office 118 may receive direct transmissions of ultrasound images on a personal computer 120, for example, by means of a wired or wireless link 122. The arrows in FIG. 1 represent exemplary directions in which information may be flowing.

The ultrasound apparatus 102 includes a processor 124 in bi-directional communication with a user interface 126, memory unit 128, image storage medium 130, and an ultrasound probe 131 which emits sound toward and receives echoes from the subject 106. The user interface includes an input device 132 and preferably an output device such as a display screen or monitor 134 and an image printer 136. Although not shown in the drawings, the user interface 126 typically displays current values of imaging parameters and may include slider controls for adjusting others of the imaging parameters and therefore the image on display 134. The input device 132 has several actuators such as buttons 138, 140, 142 for saving an image, transmitting an image externally, and enabling/disabling the learning function, respectively.

The memory unit 128 may include any combination of volatile, non-volatile and fixed memory for storing computer programs, including, for example, an operating system and to provide working storage. The image storage medium 130 is preferably any known or suitable removable medium for storing images.

As mentioned above, the current position of each slider of the slider controls represents a respective imaging parameter. In particular, each slider control pertains to a gain or factor increase that is applied to echoes received back at the probe 131. The echoes emanate from reflection off of different structures within the body 106 being imaged. Generally, the magnitude of the returning echo indicates structure that is then represented in the imaging. One complicating factor is that magnitudes will also vary with the distance of travel within the body of the subject 106. This factor is generally compensated for by use of time gain compensation (TGC). In this technique, the returning echo is allocated to adjoining time intervals. To the later-occurring time intervals, more gain is applied in accordance with the TGC curve. One slider relates to the applied gain for a particular time interval, while another of the sliders relates to gain applied in a different time interval. The gains of adjacent intervals may be varied within an interval to smooth out the gain curve or “time gain compensation” (TGC) curve at the times between adjacent intervals.

In operation, and referring to FIGS. 1 and 2 as exemplary embodiments, the user 104 maneuvers the probe 131 to bring into view a relevant image 210, e.g., of a fetus. The imaging parameters 220 at this time are the current defaults. Thus, for example, the ultrasound apparatus 102 may include mechanical means (not shown) that have already shifted the sliders into respective positions representative of default values. Other displayed parameter values are also the current defaults. The user interface (UI) parameters also include parameters whose current values correspond to the current state of the buttons 138, 140, 142. These latter parameter values are transmitted to the learning tool 230.

Once the relevant image 210 is brought into view, the user 104 may manually shift the sliders while viewing the image to correct the image. This step is shown in FIG. 2 as step 240. When the image appears as desired, it may be saved to memory 130 or transmitted out over the link 122 as a finalized image 250.

Concurrent with the saving or external transfer of the image 250, the learning tool stores the current imaging parameters, some or all of which may have just been corrected. For each of these parameters, the learning tool uses the current value just stored and at least one previously stored value to compute an average, or, alternatively, the most frequently occurring value. The computed statistic becomes the default value for the parameter. These default values are preferably supplied to the user interface, as through display or slider position. The entire process may then be repeated for a next image 210.

The learning enable/disable button 142 is an optional feature. In one implementation, pressing the button enables the learning tool 230 for the current image. Accordingly, when the user 104 presses the save or transmit button 138, 140, the user interface 126 may, for example, prompt the user as to whether learning is to be activated. If the user 104 presses the learning button 142, learning is enabled and processing proceeds as explained above. A button or other control may be provided, and if actuated, would disable learning for the current image. The user 104 might want to disable learning if, for example, the current image has been adjusted for apparatus test purposes, and has no bearing in predicting how parameters might be set from now on. In another embodiment, the learning enable/disable button 142 is pressed only to disable learning for the current image, learning being otherwise enabled.

One possible, additional user control (not shown) for the input device 132 may indicate the type of ultrasound interrogation being performed in the event the device is used for different kinds of examinations. The storing of the values, and computation of defaults based on the stored values, may be compartmentalized according to the type of ultrasound examination. Therefore, a history of values for a parameter utilized in fetal examination may be segregated from the history of values for that same parameter in conducting cardiac examination.

FIG. 3 provides, as an example, additional details on how the invention operates. Initially, the user interface displays respective default values and represents other default values, as by automatically shifting sliders, after the user learning tool 230 has calculated defaults based on the previously-processed image (step S304). The representing of default values may also involve other physical movements such as the rotating of dial pointers. Any image initially displayed depends upon the current parameter values which are the defaults and the positioning of the probe 131 (step S308). Provided the user 104 has not pressed the save or export buttons 138, 140 (step S312), the user may manually maneuver the probe 131 and correct imaging parameters via the input device 132 to achieve a desired image (step S316). Once the user has pressed either of the buttons 138, 140, current values of preferably all the imaging parameters are saved (step S320).

At this point, the processor 124 calculates default values, parameter-by-parameter, for use with respect to the next image to be processed. Pointing to the first parameter (steps S324, S328), the default is calculated based on the current value, and a set number of past values, of the parameter (step S332). The calculated default value is then saved into an operating system registry in the memory 128 or is otherwise saved to a file (step S336). The next parameter is then processed (step S340). When the last parameter has been processed (step S328), the current default values just calculated are reflected on the user interface 126 (step S304).

Calculating of the default value based on the current, and at least one past, value, may amount to computing an average value. Preferably, this average is a rolling average. FIG. 4 depicts one possible implementation, in this case with a learning curve K of 3 summands. Each loop back from step S328 to step S304 is considered to begin a new iteration. It is further assumed that the current iteration is n−2. The current value of the parameter is P(n−2). With a learning curve equal to 3, the current value of the parameter is summed together with the past two values from iterations n−3 and n−4. The sum is divided by 3 to arrive at the new default value 404. The next iteration is n−1. The now, current value is summed with the past two values, i.e., from iterations n−2 and n−3, and the sum is divided by three to arrive at the current default value 408. The learning curve parameter K can be considered the width of a sliding window on the ordered summands. In the above example, that width is 3, although fewer than 3 summands are available until the fourth iteration. Thus, the first time an image is saved or exported, the present value, which may merely be a default value either modified or unmodified, is saved and becomes the default value for the second iteration. In the second iteration, that saved default value is averaged with the current value to produce the default value which is saved and supplied for the third iteration. In the third iteration, the current value is averaged with the previous two saved values, thereby achieving a full window of summands for the first time. Each subsequent iteration enjoys the full learning curve of three summands. If a parameter has discrete values, averaging may be rounded up or down to the nearest discrete value in determining the default value.

Although 3 is a preferred quantity, the user 104 can modify the value K as desired to reflect further or less far into the past. The average may also be made a weighted average 410. Therefore, for example, if recent experience is to be accorded more consideration, the lower-valued coefficients aᵢ, which belong to the more recent values, are made larger.

If the parameter assumes discrete values which are not numerical, a selection is made of a default from among these discrete values. The ultrasound image may, for example, be colored in one of three distinct colors: red, blue and green. The different colors may correspond to respective compression techniques operating on the dynamic range of returning ultrasound echoes. Therefore, a red image may result from taking the logarithms of an echo magnitudes and then mapping the dynamic range to a displayable range, while a blue image results from performing the mapping without applying logarithms. The end-user such as the patient, relative or friend may be shown the image of a fetal baby's face in one color, and, after being told of the other color options, request a subsequent image in another color. At that point, the user will modify the displayed default color (step S316) if the default is not identical to the newly-indicated color and produce the new image. This may be a recurring process, each time for a different patient. Referring again to FIG. 4, a default 412 is calculated in iteration n−1 based on the current value and each of the past values for iterations n−2, n−3 and n−4. It is assumed for this example that the learning curve parameter K is equal to four, although any quantity may be used. Notably, however, averaging is not used, because the values of the parameter are not numerical. Instead, among the alternative, possible values, selection is made of the alternative with the highest plurality of occurrence. The pluralities of occurrence for red, blue and green, at iteration n−1, are 2, 1 and 1, respectively. In particular, red was the saved value for each of iterations n−2 and n−3 and therefore has a plurality of occurrence of two. Since this is the highest plurality, red is chosen as the default value at iteration n−1. Preferably, the highest plurality is chosen on a rolling window. Thus, for example, in iteration n, the oldest value is excluded and the current value is used. The current value is red, and the three past values are blue, red and red, respectively. The highest plurality of occurrence belongs to red, once again. Red, consequently, is chosen in iteration n as the default value 416 for the next iteration. In iteration n+3, blue has the highest plurality of occurrence, with two occurrences, and is chosen as the default value 420.

The learning tool 230 of the present invention optimizes the parameter default values by learning from the user 104. For example, any stretches in which the user 104 is not modifying a parameter, automatically result in retention of the default value. Sporadic, sparsely-occurring modifications tend to be prevented from largely altering a user-desired default. If, on the other hand, doctors or patients, who may vary from iteration to iteration, tend to make modifications with any significant frequency, the defaults are appropriately biased. Unexplainable trends may also contribute to learning. Thus, it may not be clear whether end-user preferences for a particular color stem from color preference or from compression-related differences in the image, but frequent modifications will nevertheless be taken into account, automatically or at the touch of a button.

While there have been shown and described what are considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. An apparatus for learning, from a user interface having an input device and an output device, default values to supply for executing a process on the apparatus, said apparatus comprising:
a memory; and
a processor configured for detecting a desired result of said executing and, in response, saving to the memory current values of parameters and determining, for a parameter of said parameters, a default value based on the current value of said parameter and at least one previously-saved value of said parameter, said processor supplying the determined default value to the user interface for possible modification by the user using the input device.

2. The apparatus of claim 1, wherein said detecting is from the user interface and in response to a user using the user interface.

3. The apparatus of claim 1, wherein the detecting of said desired result occurs when output of said process is saved, or transmitted externally from the apparatus for presentation other than on said user interface.

4. The apparatus of claim 1, wherein the determining comprises averaging said default value based on the current value of said parameter and said at least one previously-saved value of said parameter.

5. The apparatus of claim 4, wherein the averaging comprises computing a rolling average.

6. The apparatus of claim 4, wherein the averaging comprises computing a weighted average.

7. The apparatus of claim 1, wherein the apparatus comprises an ultrasound imaging apparatus.

8. The apparatus of claim 1, wherein said input device includes a control by which the user can select between enabling and disabling said determining.

9. The apparatus of claim 1, wherein said current value of said parameter and said at least one previously-saved value of said parameter have been chosen from among a predetermined number of alternatives, and wherein said determining selects from among the alternatives an alternative with the highest plurality of occurrence.

10. The apparatus of claim 9, wherein said plurality is a rolling plurality.

11. A method for learning, from a user interface to an apparatus, default values to supply for executing a process on the apparatus, said method comprising the acts of:
a) detecting, in response to said executing, a desired result of said executing;
b) upon said detecting, saving current values of parameters;
c) responsive to said saving, determining, for a parameter of said parameters, a default value based on the current value of said parameter and at least one previously-saved value of said parameter;
d) supplying the determined default value to the user interface for possible modification by the user; and
e) returning to act a).

12. The method of claim 11, wherein said detecting is from the user interface and in response to a user using the user interface.

13. The method of claim 11, wherein the detecting of said desired result occurs when output of said process is saved, or transmitted externally from the apparatus for presentation other than on said user interface.

14. The method of claim 11, wherein the determining comprises averaging said default value based on the current value of said parameter and said at least one previously-saved value of said parameter.

15. The method of claim 14, wherein the averaging comprises computing a rolling average the number of summands for which reaches a maximum after a sufficient number of iterations of the acts a) to d).

16. The method of claim 11, wherein the apparatus comprises an ultrasound imaging apparatus.

17. The method of claim 11, further including the act of selecting, by means of a control on the user interface, between enabling or disabling said determining.

18. The method of claim 11, wherein said current value of said parameter and said at least one previously-saved value of said parameter have been chosen from among a predetermined number of alternatives, and wherein said determining selects from among the alternatives an alternative with the highest plurality of occurrence.

19. The method of claim 18, wherein said plurality of occurrence is calculated from among a number of occurrences within a window, said number reaching a maximum after a sufficient number of iterations of the acts a) to d).

20. The method of claim 11, further comprising the acts of:
presenting to a particular end-user of said process said desired result from only some of the iterations in performing the acts a) to d);
next, receiving feedback from said end-user on the presented results; and
using the user interface to modify, based on the feedback, a value of said parameters.

21. A computer program product having a medium readable by a computer, said medium containing a learning tool for utilizing a user interface to an apparatus for executing a process on the apparatus, and, in particular, containing instructions for performing the acts of:
a) detecting, in response to said executing, a desired result of said executing;
b) upon said detecting, saving current values of parameters;
c) responsive to said saving, determining, for a parameter of said parameters, a default value based on the current value of said parameter and at least one previously-saved value of said parameter;
d) supplying the determined default value to the user interface for possible modification by the user; and
e) returning to act a).
